(19) United States
(12) Patent Application Publication
(10) Pub. No.: US 2016/0338385 A1
(43) Pub. Date: Nov. 24, 2016

(54) PROCESS FOR MAKING MEAT CHIPS

(71) Applicant: Eckkehard Willutzki, Lombard, IL (US)

(72) Inventor: Eckkehard Willutzki, Lombard, IL (US)

(21) Appl. No.: 14/719,606

(22) Filed: May 22, 2015

(51) Int. Cl. A23L 1/317

(52) U.S. Cl. CPC A23L 1/3177; A23V 2002/00

(57) ABSTRACT

Processes for manufacturing meat chips including the steps of chilling meat, adding water to the meat, and grinding the chilled meat to form a ground, chilled mixture; placing the ground, chilled mixture in forms, and baking the mixture; and removing the mixture from the forms, slicing the mixture, and dehydrating the slices.

### BACKGROUND OF THE INVENTION

The present invention generally relates to processes for preparing meat. For specifically, the invention relates to a process for making meat chips.

The inventor is a butcher who is not currently aware of any repeatable processes for making edible, commercially acceptable, dehydrated meat chips from lean meat. The inventor discovered that meat, while about 70% water, can actually absorb much more water than that—even more water than its weight. By causing meat to absorb so much water, the meat expands, such that when it is cooked and then dried, it will provide a different, fluffier texture than it would otherwise have.

Accordingly, it would be advantageous to provide a new process for treating meat, providing an advantageous texture for making meat chips.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Form” includes any forms or flexible shaping materials for forming or holding meat or meat mixtures, including but not limited to rigid metal or metallic forms, flexible casings, including animal-based casings, foil or plastic.

“Chilled water” includes ice, snow and chilled water at or near a freezing temperature.

### SUMMARY OF THE INVENTION

The objects mentioned above, as well as other objects, are solved by the present invention, which overcomes disadvantages of prior meat preparation processes, while providing new advantages not previously obtainable with such processes.

One preferred embodiment of the present invention includes a process for making meat chips is provided, which includes chilling meat (such as to an initial temperature of about 32° F.), adding chilled water to the meat (such as 80%-120% by weight of the meat, and most preferably about 110% of the weight of the meat), and grinding or cutting the chilled meat (such as for about 2 and ½-3 minutes) to form a ground, chilled mixture (preferably during grinding the meat is not permitted to elevate about 40° F.). (Room-temperature water may be added to frozen meat or, alternatively, chilled water may be added to room-temperature or chilled meat.) The ground, chilled mixture may then be placed in forms (such as sausage-shaped forms, for example), and baked. Baking preferably continues until the inside temperature of the mixture reaches about 150° F. After baking, the mixture may be removed from the forms, sliced, and dehydrated. Dehydration may take place in a dehydrator or an oven for about 6-8 hours, such as 7 hours.

Preferably, the meat comprises a lean meat with less than 1% fat by weight, such as one or more of the following: chicken; venison or pork.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

Various processes for making meat chips may be employed within the spirit of the present invention. One such process is now described. A lean meat, such as chicken breast, within less than or equal to about 1% fat, may be ground in a meat grinder (such as a 2 hp or 3 hp Ninja meat grinder, or a Buffalo bowl-type meat grinder) or cut or shredded, and mixed with spices. (Some meats, such as chicken thighs or pork, will need to be ground in a meat grinder; other meats, such as poultry breast, need not be ground, and may simply be cut or shredded in a Ninja processor, for example). Now, about 80%-120% chilled water by weight, most preferably about 100%-110% water by weight, may be added to the ground or cut meat. The water may be chilled in an ice bath, or may be added in the form of snow (which may be provided by using a Ninja mixer, for example). (If more water is used, drainage should be provided, as a lean meat may be unable to absorb more than about 120% by weight of water.) Optionally, about 1 gram of phosphate for each pound of meat may be mixed in, as well (to enhance mixing, and better hold water). Mixing within the meat grinder may occur for about 2 and ½-3 minutes. During mixing, the mixture may be allowed to elevate in temperature to about 40° F.

The mixture may now be placed in forms (such as sausage-shaped metallic forms), which have been preferably sprayed with butter or another degreasing agent. Once inside the forms, the mixture may be heated to about 180° F., and removed from heat once the inside of the mixture within the forms reaches about 150° F. (As a general rule of thumb, this temperature may be reached when the external temperature is held at about 180° F. for about 1 minute/1 millimeter of round thickness, or about 1 hour for a 60-mm diameter sausage-shaped link). Once an internal temperature of about 150° F. is reached, the cooked meat may now be removed from the forms, sliced to a desired form (such as in cylindrical slices of about ⅛-inches- 3/16-inches thick), and placed in a dehydrator oven for a substantial time period, until dried, fluffy meat chips result. One preferred method of dehydration is using a dehydrator, such as for about 6-8 hours, and most preferably about 7 hours.

In an alternative process to that described above, the process may begin using frozen, spiced meat, and room temperature water, followed by the grinding, placing in forms, cooking and dehydrating steps as described above.

It should be understood that a better quality meat (e.g., meat from the neck is better than meat from the hindquarters of an animal, and a young animal is better than an old animal) can absorb more water. Conversely, a lower water content will result in a harder (less fluffy, and likely less desirable) meat chip.

Using the above-described techniques, various lean, meat-based products may be processed, including chicken chips, pork chip and venison chips.

The above description is not intended to limit the meaning of the words used in the following claims that define the invention. For example, while various preferred and less preferred embodiments have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

1. A process for making meat chips, comprising the steps of:
mixing water, including at least some water in solid form, to meat, with the water being present in an amount equal to about 80%-120% by weight of the meat;
grinding or cutting the meat to form a ground, chilled mixture;
placing the ground or cut, chilled mixture in forms, and baking the mixture; and
removing the mixture from the forms, slicing the mixture, and dehydrating the slices for a substantial time period until dried meat chips are formed.

2. The process of claim 1, wherein the meat comprises a lean meat with less than 1 % fat by weight.

3. A process for making meat chips, comprising the steps of:
adding frozen meat to room temperature water in an amount equal to about 80%-120% by weight of the meant to form a chilled meat/water mixture;
grinding or cutting the meat to form a ground, chilled mixture;
placing the ground, chilled mixture in forms, and baking the mixture; and
removing the mixture from the forms, slicing the mixture, and dehydrating the slices in a dehydrator oven for not less than about 6 hours.

4. (canceled)

5. The process of claim 1, wherein chilled water is added in an amount equal to about 100%-110% by weight of the meat.

6. The process of claim 1, wherein chilled water is added to the meat prior to the grinding or cutting step.

7. The process of claim 1, wherein the mixture is ground for about 2-3 minutes.

8. The process of claim 1, Wherein the temperature of the mixture does not exceed 40° F. during grinding or cutting.

9. The process of claim 1, wherein the meat comprises one or more of the following: chicken; venison; or pork.

10. The process of claim 1, wherein the mixture is baked until the inside temperature of the mixture reaches about 150° F.

11. The process of claim 1, wherein the slices are dehydrated for between about 6-8 hours.

12. The process of claim 1, wherein a degreasing agent is placed on the inner surface of the forms prior to adding the chilled mixture to the forms.

13. The process of claim 1, wherein the chilled water comprises ice.

14. The process of claim 1, wherein the dehydrated slices comprise chicken and is in the form of chicken chips.

15. A process for making meat chips, comprising the steps of:
adding water to frozen meat, the water being in an amount of about 80%-120% by weight of the meat;
grinding or cutting the meat to form a ground or cut, chilled mixture;
placing the ground or cut, chilled mixture in forms, and baking the mixture; and
removing the mixture from the forms, slicing the mixture, and dehydrating the slices by placing the slices in a dehydrator oven for not less than about 6-8 hours.

16. The process of claim 1, wherein the slices are heated in a dehydrator oven for about 6-8 hours, until the slices comprise dried meat chips.
